(19) United States
(12) Patent Application Publication
(10) Pub. No.: US 2008/0192581 A1
(43) Pub. Date: Aug. 14, 2008

(54) Analog radio-controlled timepiece

(76) Inventor: Kenji Ogasawara, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/011,972

(22) Filed: Jan. 30, 2008

(30) Foreign Application Priority Data
Feb. 6, 2007 (JP) 2007-027016

(51) Int. Cl. G04C 11/02

(52) U.S. Cl. 368/47

(57) ABSTRACT

To provide an analog radio-controlled timepiece in which it is possible to set a displayed date by a date indicator to a correct date. A reception circuit 115 receives and outputs a time code included in a standard radio signal through an antenna 114, and a control circuit 103 corrects a time instant being clocked to a time instant corresponding to the time code and corrects a clocked time instant of a 24-hour counter 116 to the last-mentioned time instant. Even in a case where the standard radio signal cannot be received, the control circuit 103 drive-controls a motor 105 so as to alter a displayed date of a date indicator 107 to a next day in a case where the 24-hour counter clocked 24 hours. The motor 105 rotation-drives the date indicator 107 for one day through the train wheel 106, thereby altering the displayed date to the next day.

### BACKGROUND OF THE INVENTION

1. Field of the Invention

The present invention relates to an analog radio-controlled timepiece receiving a standard radio signal including a time code indicating a present time instant by a radio, thereby performing a time instant correction on the basis of the time code.

2. Description of the Related Art

From olden times, there is utilized a radio-controlled timepiece receiving the standard radio signal including the time code indicating the present time instant by the radio, thereby correcting a time instant in an inside of the radio-controlled timepiece to a time instant corresponding to the time code. Even in a case where a clock error occurs in the radio-controlled timepiece, it is possible to display while being corrected to an accurate time instant by correcting the time instant on the basis of the received time code.

By the way, like a radio-controlled timepiece described in Japanese Patent No. 3603903 Gazette (Paragraphs [0028]-[0067], FIG. 1-FIG. 7), there is developed an analog radio-controlled timepiece which is made such that, by receiving the standard radio signal, a time instant displayed by time instant hands and a time instant of the time code are synchronized.

However, in the radio-controlled timepiece described in the above Japanese Patent No. 3603903 Gazette, there is not made such that a displayed date by a date indicator is set to a present date. Accordingly, in a case where, even if the displayed date by the date indicator is set, the standard radio signal cannot be received, there is an issue that the displayed date by the date indicator cannot be set to a correct date because it is impossible to rotation-control the date indicator.

### SUMMARY OF THE INVENTION

It is an aspect of the present invention to provide an analog radio-controlled timepiece in which it is possible to set the displayed date by the date indicator to the correct date.

It is another aspect of the present invention to provide an analog radio-controlled timepiece possessing a reception means receiving a standard radio signal including a time code indicating a present time instant by a radio, a clock means clocking a time instant, time instant hands analog-displaying a time instant, a first motor rotation-driving the time instant hands, a date indicator having at least date letter and performing a date display by the date letter, a second motor rotation-driving the date indicator, a time instant correction means correcting the time instant that the clock means is clocking to a time instant corresponding to the time code received by the reception means, a control means which, by controlling the first motor and the second motor in compliance with the clocked time instant of the clock means in an ordinary mode for performing a date/time display, displays a time instant by the time instant hands and displays a date by the date indicator, an operation means capable of operating the time instant hands and the date indicator, and a 24-hour clock means clocking 24 hours, wherein in a case where the reception means could not receive the standard radio signal normally, the control means controls the second motor so as to alter a displayed date of the date indicator to a next day when the 24-hour clock means clocked the 24-hours.

In the case where the reception means could not receive the standard radio signal normally, the control means controls the second motor so as to alter the displayed date of the date indicator to the next day when the 24-hour clock means clocked the 24 hours.

Here, there may be constituted such that, in a case where the reception means could normally receive the standard radio signal, the control means replaces a clocked time instant of the 24-hour clock means with a time instant of the time code included in the standard radio signal.

Further, there may be constituted such that, in a case where the reception means could normally receive the standard radio signal, the control means controls the second motor so as to alter the displayed date of the date indicator to the next day when a value obtained by subtracting a clocked time instant of the 24-hour clock means from a time instant corresponding to the time code included in the standard radio signal is minus.

Further, there may be constituted such that, when the operation means was predetermination-operated, the control means resets a clocked time instant of the 24-hour clock means to 0 o'clock, and the 24-hour clock means starts a clock operation from the 0 o'clock by the reset.

Further, there may be constituted such that a crown is included in the operation means and, when the 24-hour clock means clocked the 24 hours under a state in which the crown existed in its ordinary non-operated position, the control means controls the second motor so as to alter the displayed date of the date indicator to the next day.

Further, there may be constituted such that, when the crown is predetermination-operated, the control means resets a clocked time instant of the 24-hour clock means to 0 o'clock, and the 24-hour clock means starts a clock operation from the 0 o'clock by the reset.

Further, there may be constituted such that an operation button is additionally included in the operation means and, when the operation button was operated under a state in which the crown existed in a date indicator operable position capable of alteration-operating a displayed date of the date indicator, the control means controls the second motor so as to alter the displayed date of the date indicator in response to an operation of the operation button.

According to the present invention, it becomes possible to set the displayed date by the date indicator to the correct date.

### BRIEF DESCRIPTION OF THE DRAWINGS

FIG. 1 is a block diagram of an analog radio-controlled timepiece concerned with an embodiment of the present invention.

FIG. 2 is an external appearance view of the analog radio-controlled timepiece concerned with the embodiment of the present invention.

FIG. 3 is a flowchart showing processing in the analog radio-controlled timepiece concerned with the embodiment of the present invention.

FIG. 4 is a flowchart showing processing in the analog radio-controlled timepiece concerned with the embodiment of the present invention.

### DESCRIPTION OF THE PREFERRED EMBODIMENTS

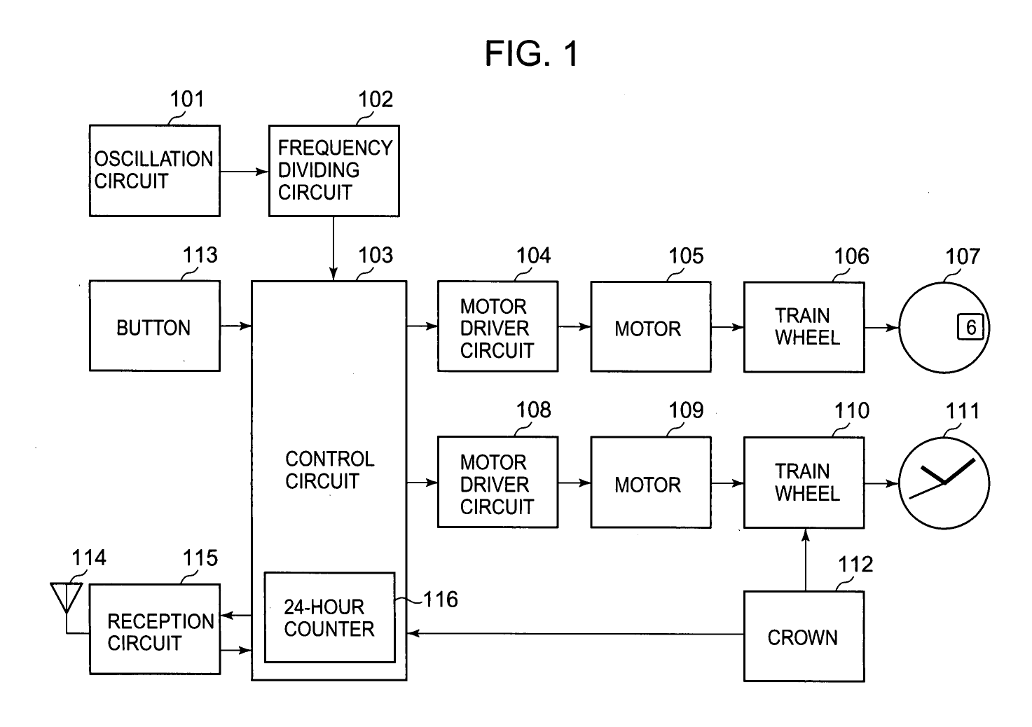

FIG. 1 is a block diagram of an analog radio-controlled timepiece concerned with an embodiment of the present invention, and shows an example of a wristwatch type analog radio-controlled timepiece.

In FIG. 1, the analog radio-controlled timepiece possesses an oscillation circuit 101 outputting a signal of a predetermined frequency, a frequency dividing circuit 102 frequency-dividing the signal from the oscillation circuit 101 to thereby output a time signal becoming a reference of a clock operation, a control circuit 103 performing the clock operation basing on the above time signal to thereby perform an output processing of a control signal for a time instant display and a control processing of each constituent element of the analog radio-controlled timepiece or a later-mentioned-processing etc., a motor driver circuit 108 responding to a control signal from the control circuit 103 to thereby output a motor drive signal for time instant hands, a motor 109 rotation-driven by the motor drive signal for time instant hands, a train wheel 110 transmitting a rotation of the motor 109, and time instant hands (hour hand, minute hand, second hand) 111 rotation-driven by the train wheel 110.

Further, the analog radio-controlled timepiece possesses a motor driver circuit 104 responding to the control signal from the control circuit 103 to thereby output a motor drive signal for a date indicator, a motor 105 rotation-driven by the motor drive signal for the date indicator, a train wheel 106 transmitting a rotation of the motor 105, and a date indicator 107 rotation-driven by the train wheel 106. In the date indicator 107, date letters indicating dates of 1st day-31st day are provided by an imprinting or the like. Incidentally, in FIG. 1, there is shown a case where a displayed date by the date indicator 107 is a 6th day.

Further, the analog radio-controlled timepiece possesses an antenna 114 receiving the standard radio signal including the time code by the radio, a reception circuit 115 outputting the time code included in the standard radio signal received by the antenna 114, a crown 112 performing a time instant setting of the time instant hands 111 by driving the train wheel 110 by a predetermined manual operation and having a function inputting an operation signal complying with the manual operation to the control circuit 103, or the like, and an operation button 113 capable of being operated manually. There is constituted such that, by causing the crown 112 and the operation button 113 to cooperate, the date indicator 107 can be rotation-driven by a manual operation.

Further, the control circuit 103 has in its inside a 24-hour counter 116 clocking 24 hours.

Here, the antenna 114 and the reception circuit 115 constitute a reception means receiving the standard radio signal including the time code by the radio, the motor 109 constitutes a first motor, and the motor 105 constitutes a second motor. The crown 112 and the operation button 113 constitute an operation means. The 24-hour counter 116 constitutes a 24-hour clock means. Further, the control circuit 103 constitutes, by counting the time signal, a clock means clocking a present time instant, a time instant correction means correcting the present time instant being clocked to a time instant corresponding to the received time code, and a control means.

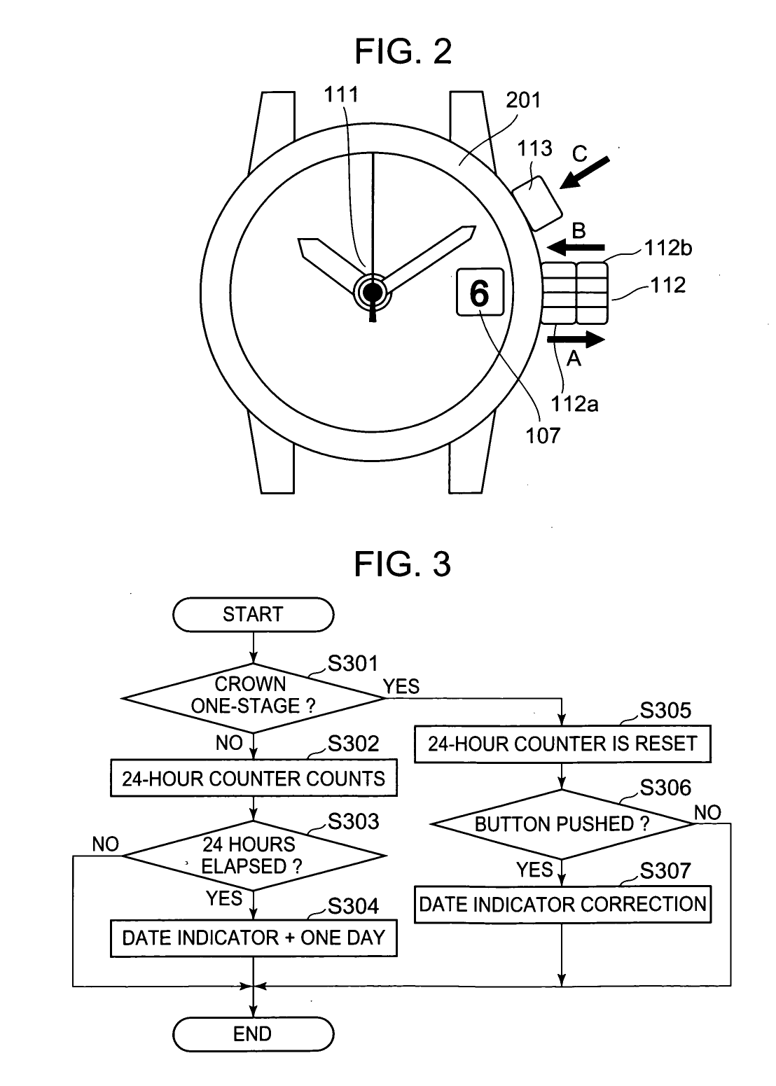

FIG. 2 is a view showing an external appearance of the analog radio-controlled timepiece concerned with the embodiment of the present invention, and the same reference numeral is applied to the same portion as FIG. 1. 201 is a case of the analog radio-controlled timepiece and, in FIG. 2, there is shown a state in which the date indicator 107 displays the 6th day similarly to FIG. 1.

The crown 112 is constituted so as to be capable of being switched to two positions of an ordinary position (position of 112a which is a 0-stage position) not operated, and a date indicator operable position (position of 112b) which is a position pulled by one-stage in an arrow A direction from the ordinary position 112a and a position in which the manual operation of the time instant hands 111 is possible and the manual operation of the date indicator 107 becomes possible by an operation of the operation button 113. The crown 112 returns to the above ordinary position 112a by being push-operated in an arrow B direction from the date indicator operable position 112b.

Although the operation-button 113 is constituted so as to be push-operable in an arrow C direction from a position shown in FIG. 2, since it is biased in a direction reverse to the arrow C, there is constituted so as to return to the position shown in FIG. 2 by the bias force in every time it is push-operated in the arrow C direction.

FIG. 3 is a flowchart showing processing made such that an alteration of the displayed date of the date indicator 107 can be performed even in a case where the standard radio signal cannot be received normally in the embodiment of the present invention, and shows mainly the processing of the control circuit 103.

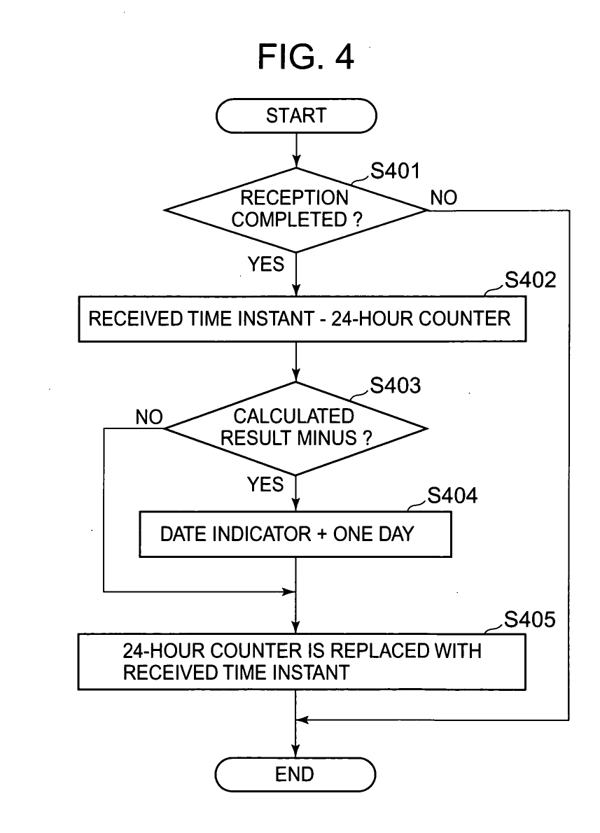

Further, FIG. 4 is a flowchart showing processing when altering the displayed date of the date indicator 107 in a case where the standard radio signal could be received normally, and shows mainly the processing of the control circuit 103.

Hereunder, by referring to FIG. 1-FIG. 4, there is explained an operation of the analog radio-controlled timepiece concerned with the present embodiment.

In an ordinary mode performing a date-time display by performing a clock operation basing on a timepiece signal from the frequency dividing circuit 102, the analog radio-controlled timepiece performs a clock operation by the fact that the control circuit 103 counts the timepiece signal from the frequency dividing circuit 102 (At this time, the control circuit 103 functions as the clock means.), and outputs control signals (a control signal for the date indicator, for rotation-controlling the date indicator 107, and a control signal for the time instant hands, for rotation-driving the time instant hands 111), which correspond to the clocked-time instant, respectively to the motor driver circuits 104, 108 (At this time, the control circuit 103 functions as the control means.).

The motor driver circuit 108 rotation-drives the motor 109 by a motor drive signal for the time instant hands, which corresponds to the control signal for the time instant hands. The motor 109 rotation-drives the time instant hands 111 through the train wheel 110, thereby performing an analog display of the present time instant by the time instant hands 111.

Further, as mentioned later, the control circuit 103 outputs, under a predetermined condition, the control signal for the date indicator to the motor driver circuit 104. The motor driver circuit 104 rotation-drives the motor 105 by a motor drive signal for the date indicator, which corresponds to the control signal for the date indicator. The motor 105 rotation-drives the date indicator 107 through the train wheel 106, thereby altering the displayed date to a date of next day.

Next, in relation to an operation of a time instant correction mode performing the time instant correction by receiving the time code included in the standard radio signal, a general operation is explained roughly. Incidentally, a characteristic operation of the present embodiment in the time instant correction mode is mentioned later.

In the time instant correction mode, when a predetermined time instant for automatically performing the time instant correction arrived, or when a predetermined operation by the operation button 113 was performed, the control circuit 103 causes the reception circuit 115 to perform a reception operation of the standard radio signal by making an electric source of the reception circuit 1150N. The reception circuit 115 outputs the time code included in the standard radio signal received by the antenna 114 to the control circuit 103.

At this time, in a case where the time instant hand 111 (especially, the second hand) is rotation-driven in order to continue to display own time instant being clocked during the reception of the standard radio signal, the control circuit 103 controls the motor 109 so as to rotation-drive the time instant hand 111 between a pulse signal and a pulse signal (in an interstice between the pulse signals), which constitute the time code included in the standard radio signal. By this, a drive of the time instant hand is performed. At this time, even in a case where a noise generates by the drive of the motor 109, it is possible to prevent a false detection of the time code by the noise.

In a case where the standard radio signal could be received normally, the control circuit 103 corrects own clocked time instant to an accurate present time instant corresponding to the time code (At this time, the control circuit 103 functions as the time instant correction means.), and outputs a control signal corresponding to the accurate present time instant to the motor driver circuit 108. The motor driver circuit 108 rotation-drives the motor 109 by a drive signal corresponding to the control signal, and the motor 109 rotation drives the time instant hands 111 through the train wheel 110, thereby performing an analog display of the accurate present time instant corresponding to the time code.

Incidentally, in a case where the time instant is corrected by the manual operation, the crown 112 is made the date indicator operable position 112b by being pulled by one-stage in the arrow A direction, under this state the train wheel 110 is rotation-driven by manually operating the crown 112 to thereby perform a time-instant setting of the time instant hands 111, and a time instant information corrected by the crown 112 is inputted to the control circuit 103. By this, the clocked time instant of the control circuit 103 and the displayed time instant by the time instant hands 111 are coincided.

Further, in a case where the displayed date of the date indicator 107 is altered by a manual motion, there is performed by push-operating the operation button 113 under a state in which the crown 112 is made the date indicator operable position 112b by being pulled by one-stage as mentioned later.

Next, there is explained an operation correcting the displayed date of the date indicator 107 in a case where the standard radio signal could not be received normally.

In FIG. 3, the control circuit 103 judges whether or not the crown 112 was set to the date indicator operable position 112b by being pulled by one-stage in the arrow A direction (a step S301) and, in a case where there was judged that it was set to the date indicator operable position 112b, the clocked time instant of the 24-hour counter 116 is reset and made 0 o'clock (a step S305).

Next, the control circuit 103 judges whether or not the operation-button 113 was push-operated in the arrow C direction (a step S306) and, in a case where there was judged that it was push-operated, the control signal for the date indicator, for rotating the date indicator 107 so as to be unlocked (date indicator correction) by one day at a time in every time the push operation of the operation button 113 is performed, is outputted to the motor driver circuit 104 (a step S307).

The motor driver circuit 104 performs an unlocking operation of the date indicator 107 by one day at a time through the motor 105 and the train wheel 106 while responding to each of the control signal for the date indicator from the control circuit 103. By this, it follows that, under a state in which the crown 112 was made the date indicator operable position 112b in which it was pulled by one-stage, the displayed date of the date indicator 107 is successively changed to the next day in every time the operation button 113 is push-operated.

After the above date indicator correction, if the crown 112 is returned to the ordinary position 112a by being operated in the arrow B direction, the 24-hour counter 116 starts the clock operation for 24 hours from a state of the reset 0 o'clock.

On the other hand, in a case where the control circuit 103 judged in the processing step S301 that the crown 112 was not set to the date indicator operable position 112b, it causes the 24-hour counter 116 to continue the clock operation (a step S302).

The control circuit 103 judges whether or not the 24-hour counter 116 clocked the 24 hours (a step S303) and, when it judged that the 24 hours were clocked, it outputs the control signal for the date indicator to the motor driver circuit 104 so as to alter the displayed date of the date indicator 107 to the next day by adding one day to the displayed date of the date indicator 107 (a step S304).

The motor driver circuit 104 rotation-controls the date indicator 107 through the motor 105 and the train wheel 106 such that the date indicator 107 rotates for one day and the displayed date becomes the next day. Incidentally, the processing steps S301-S307 in the control circuit 103 constitute the control means.

By this, even in a case where the standard radio signal could not be received normally, it becomes possible to alter the displayed date of the date indicator 107. Incidentally, in order to perform the displayed date alteration of the date indicator 107 at about 24 o'clock, it is possible to perform a more accurate displayed date alteration by previously setting a setting of the date to an accurate date and resetting the 24-hour counter 116 to about 24 o'clock.

Next, there is explained an operation when altering the displayed date of the date indicator 107 in a case where the standard radio signal could be received normally.

In FIG. 4, if the standard radio signal is received by operating the reception circuit 115 and the accurate time code included in the standard radio-signal is all received from the reception circuit 115, the control circuit 103 judges that the reception of the standard radio signal was completed (a step S401), and takes a difference between the present time instant (received time instant) corresponding to the time code and the clocked time instant of the 24-hour counter 116 (a step S402).

When a value obtained by subtracting the clocked time instant of the 24-hour counter 116 from the time instant of the time code is minus (a step S403), the control circuit 103 controls the motor 105 so as to alter the displayed date to the next day by adding one day to the displayed date of the date indicator 107 (a step S404).

The motor driver circuit 104 rotation-controls the date indicator 107 through the motor 105 and the train wheel 106 such that the date indicator 107 rotates for one day and the displayed date becomes the next day. By this, the displayed date of the date indicator 107 becomes an accurate displayed date.

Next, the control circuit 103 ends the processing by replacing the clocked time instant of the 24-hour counter 116 with a time instant corresponding to the received time code (a step S405).

By this, it follows that the clocked time instant of the 24-hour counter 116 is replaced with the accurate time instant. Incidentally, the processing steps S401-S405 in the control circuit 103 constitute the control means.

Accordingly, even in a case where thereafter the standard radio signal can not be received normally, it becomes possible to approximately, accurately alter the displayed date of the date indicator 107 on the basis of the clocked time instant of the 24-hour counter 116.

As mentioned above, according to the analog radio-controlled timepiece concerned with the present embodiment, in the case where control circuit 103 normally received the standard radio signal, the control circuit 103 corrects the time instant being clocked to the time instant corresponding to the time code included in the standard radio signal, and corrects the clocked time instant of the 24-hour counter 116 to the last-mentioned time instant. In the case where the standard radio signal was received, when the value obtained by subtracting the clocked time instant of the 24-hour counter 116 from the time instant of the time code included in the standard radio signal is minus, the control circuit 103 controls the motor 105 so as to alter the displayed date to the next day by adding one day to the displayed date of the date indicator 107. Further, the control circuit 103 is constituted such that, in the case where the standard radio signal cannot be received, it drive-controls the motor 105 so as to alter the displayed date of the date indicator 107 to the next day in the case where the 24-hour counter 116 clocked the 24 hours.

Accordingly, it becomes possible to set the displayed date of the date indicator 107 to a correct date.

Further, even in the case where the standard radio signal cannot be received, when the 24-hour counter 116 clocked the 24 hours, since the displayed date is altered to the next day by unlocking the date indicator 107 by one day, it becomes possible to use as an ordinary timepiece, which is not the radio-controlled timepiece, by displaying an accurate date.

Further, in the case where the standard radio signal could be received, there is brought about such an advantage that, even if the displayed date that the date indicator 107 is displaying deviates from the received date of the standard radio signal, it becomes possible to correct the deviation.

Incidentally, in the above embodiment, although there is constituted such that, by providing the crown 112 and the operation button 113 as the operation means, the displayed date is altered by the crown 112 and the operation button 113, there may be constituted such that, by providing only any one of the crown 112 or the operation button 113 as the operation means, there are performed the date correction, the time instant correction, the reset processing of the 24-hour counter 116, and the like by the operation of the operation means concerned.

There can be applied to the analog radio-controlled timepiece used in regions, such as Japan and the USA, in which there is used the standard radio signal for the time instant correction.

What is claimed is:

1. An analog radio-controlled timepiece comprising:
a reception means receiving a standard radio signal including a time code indicating a present time instant by a radio;
a clock means clocking a time instant;
time instant hands analog-displaying a time instant;
a first motor rotation-driving the time instant hands;
a date indicator having at least date letter and performing a date display by the date letter;
a second motor rotation-driving the date indicator;
a time instant correction means correcting the time instant that the clock means is clocking to a time instant corresponding to the time code received by the reception means;
a control means which, by controlling the first motor and the second motor in compliance with the clocked time instant of the clock means in an ordinary mode for performing a date/time display displays a time instant by the time instant hands and displays a date by the date indicator;
an operation means capable of operating the time instant hands and the date indicator; and
a 24-hour clock means clocking 24 hours;
wherein in a case where the reception means could not receive the standard radio signal normally, the control means controls the second motor so as to alter a displayed date of the date indicator to a next day when the 24-hour clock means clocked the 24 hours.

2. An analog radio-controlled timepiece according to claim 1, wherein in a case where the reception means could normally receive the standard radio signal, the control means replaces a clocked time instant of the 24-hour clock means with a time instant of the time code included in the standard radio signal.

3. An analog radio-controlled timepiece according to claim 1, wherein in a case where the reception means could normally receive the standard radio signal, the control means controls the second motor so as to alter the displayed date of the date indicator to the next day when a value obtained by subtracting a clocked time instant of the 24-hour clock means from a time instant corresponding to the time code included in the standard radio signal is minus.

4. An analog radio-controlled timepiece according to claim 2, wherein in a case where the reception means could normally receive the standard radio signal, the control means controls the second motor so as to alter the displayed date of the date indicator to the next day when a value obtained by subtracting a clocked time instant of the 24-hour clock means from a time instant corresponding to the time code included in the standard radio signal is minus.

5. An analog radio-controlled timepiece according to claim 1, wherein when the operation means was predetermination-operated, the control means resets a clocked time instant of the 24-hour clock means to 0 o'clock, and the 24-hour clock means starts a clock operation from the 0 o'clock by the reset.

6. An analog radio-controlled timepiece according to claim 2, wherein when the operation means was predetermination-operated, the control means resets a clocked time instant of the 24-hour clock means to 0 o'clock, and the 24-hour clock means starts a clock operation from the 0 o'clock by the reset.

7. An analog radio-controlled timepiece according to claim 3, wherein when the operation means was predetermination-operated, the control means resets a clocked time instant of the 24-hour clock means to 0 o'clock, and the 24-hour clock means starts a clock operation from the 0 o'clock by the reset.

8. An analog radio-controlled timepiece according to claim 4, wherein when the operation means was predetermination-operated, the control means resets a clocked time instant of the 24-hour clock means to 0 o'clock, and the 24-hour clock means starts a clock operation from the 0 o'clock by the reset.

9. An analog radio-controlled timepiece according to claim 1, wherein a crown is included in the operation means and, when the 24-hour clock means clocked the 24 hours under a state in which the crown existed in its ordinary non-operated position, the control means controls the second motor so as to alter the displayed date of the date indicator to the next day.

10. An analog radio-controlled timepiece according to claim 2, wherein a crown is included in the operation means and, when the 24-hour clock means clocked the 24 hours under a state in which the crown existed in its ordinary non-operated position, the control means controls the second motor so as to alter the displayed date of the date indicator to the next day.

11. An analog radio-controlled timepiece according to claim 3, wherein a crown is included in the operation means and, when the 24-hour clock means clocked the 24 hours under a state in which the crown existed in its ordinary non-operated position, the control means controls the second motor so as to alter the displayed date of the date indicator to the next day.

12. An analog radio-controlled timepiece according to claim 4, wherein a crown is included in the operation means and, when the 2-4-hour clock means clocked the 24 hours under a state in which the crown existed in its ordinary non-operated position, the control means controls the second motor so as to alter the displayed date of the date indicator to the next day.

13. An analog radio-controlled timepiece according to claim 5, wherein a crown is included in the operation means and, when the 24-hour clock means clocked the 24 hours under a state in which the crown existed in its ordinary non-operated position, the control means controls the second motor so as to alter the displayed date of the date indicator to the next day.

14. An analog radio-controlled timepiece according to claim 6, wherein a crown is included in the operation means and, when the 24-hour clock means clocked the 24 hours under a state in which the crown existed in its ordinary non-operated position, the control means controls the second motor so as to alter the displayed date of the date indicator to the next day.

15. An analog radio-controlled timepiece according to claim 7, wherein a crown is included in the operation means and, when the 24-hour clock means clocked the 24 hours under a state in which the crown existed in its ordinary non-operated position, the control means controls the second motor so as to alter the displayed date of the date indicator to the next day.

16. An analog radio-controlled timepiece according to claim 8, wherein a crown is included in the operation means and, when the 24-hour clock means clocked the 24 hours under a state in which the crown existed in its ordinary non-operated position, the control means controls the second motor so as to alter the displayed date of the date indicator to the next day.

17. An analog radio-controlled timepiece according to claim 1, wherein when the crown is predetermination-operated, the control means resets a clocked time instant of the 24-hour clock means to 0 o'clock, and the 24-hour clock means starts a clock operation from the 0 o'clock by the reset.

18. An analog radio-controlled timepiece according to claim 9, wherein an operation button is additionally included in the operation means and, when the operation button was operated under a state in which the crown existed in a date indicator operable position capable of alteration-operating a displayed date of the date indicator, the control means controls the second motor so as to alter the displayed date of the date indicator in response to an operation of the operation button.

19. An analog radio-controlled timepiece according to claim 17, wherein an operation button is additionally included in the operation means and, when the operation button was operated under a state in which the crown existed in a date indicator operable position capable of alteration-operating a displayed date of the date indicator, the control means controls the second motor so as to alter the displayed date of the date indicator in response to an operation of the operation button.
